(19) United States
(12) Patent Application Publication
(10) Pub. No.: US 2014/0044575 A1
(43) Pub. Date: Feb. 13, 2014

(54) IMPELLER DESIGN FOR FLUID PUMP ASSEMBLY AND METHOD OF MAKING

(71) Applicant: Lee A. Naffziger, Sterling, IL (US)

(72) Inventor: Lee A. Naffziger, Sterling, IL (US)

(73) Assignee: BORGWARNER INC., Auburn Hills, MI (US)

(21) Appl. No.: 13/977,983

(22) PCT Filed: Jan. 3, 2012
(86) PCT No.: PCT/US12/20034

§ 371 Date: Jul. 30, 2013

Related U.S. Application Data
(60) Provisional application No. 61/429,895, filed on Jan. 5, 2011.

(51) Int. Cl. F04D 29/18; B29C 45/00

(52) U.S. Cl. CPC F04D 29/18; B29C 45/00
USPC 417/423.1; 416/192; 264/328.1

(57) ABSTRACT

One embodiment includes an impeller (10) for use with a fluid pump assembly (12) such as a secondary air pump assembly of an automotive exhaust breathing system. The impeller has numerous vanes (50) and ribs (52). Among other things, the ribs help optimize manufacture of the impeller.

This application claims the benefit of U.S. Provisional Application No. 61/429,895 filed Jan. 5, 2011.

### TECHNICAL FIELD

The technical field generally relates to fluid pump assemblies and impellers used in fluid pump assemblies.

### BACKGROUND

Fluid pump assemblies often include impellers. One example of a fluid pump assembly is a secondary air pump assembly equipped in an automotive engine breathing system, such as an automotive exhaust breathing system. Secondary air pump assemblies typically provide secondary air to the automotive exhaust breathing system in order to help reduce pollutants in the exhaust gases discharged from the associated automotive internal combustion engine and eventually outside of the associated automobile.

### SUMMARY OF SELECT EMBODIMENTS OF THE INVENTION

One embodiment includes a product which includes an impeller of a fluid pump assembly. The impeller may have numerous vanes, a web, and numerous ribs. Each vane may have a base portion and a tip portion that is located a radial outward distance relative to the base portion. The web may extend between and may connect the vanes and the ribs. Each rib may have a base portion and a tip portion that is located a radial outward distance relative to the base portion. Some or more of the ribs may be located circumferentially between a pair of successive and neighboring vanes. A generally circumferentially-facing side surface of some or more of the ribs may generally confront a generally circumferentially-facing side surface of an immediately neighboring vane, and may define a circumferential space therebetween throughout some or more an a radial extent of the ribs.

One embodiment includes a product which includes a fluid pump assembly of an automotive exhaust breathing system. The fluid pump assembly may include a housing, an electric motor, and an impeller. The housing may have an inlet portion to receive fluid-flow, and may have an outlet portion to expel fluid-flow. The electric motor may be supported by the housing. The impeller may be located in the housing and may be rotated by the electric motor upon actuation of the electric motor. The impeller may have a hub portion and a vane portion. The vane portion may extend from the hub portion at a transition hub surface. The vane portion may have numerous vanes, a web, and numerous ribs. Each of the vanes may have a base portion located at the transition hub surface, and may have a free end located a radial outward distance relative to the base portion. Each of the vanes may have a leading side surface that generally faces in a direction of rotation of the impeller, and may have a trailing side surface that generally faces in a direction that is opposite the direction of rotation of the impeller. The web may extend between and may connect the vane and the ribs together. Each of the ribs may be located circumferentially between a pair of successive and neighboring vanes. Each of the ribs may have a base portion located at the transition hub surface, and may have a free end located a radial outward distance relative to the base portion. Each of the ribs may have a leading side surface that generally faces in the direction of rotation of the impeller, and may have a trailing side surface that generally faces in the direction that is opposite the direction of rotation of the impeller. The leading side surfaces of the vanes may generally confront the trailing side surfaces of the immediately neighboring ribs, and may be spaced a circumferential distance therefrom throughout a radial extent of the ribs from the base portions of the ribs to the free end of the ribs. The trailing side surfaces of the vanes may generally confront the leading side surfaces of the immediately neighboring ribs, and may be spaced a circumferential distance therefrom throughout a radial extent of the ribs from the base portions of the ribs to the free end of the ribs.

One embodiment includes a method. The method may include injection molding an impeller of a fluid pump assembly. The impeller may have numerous vanes, a web, and numerous ribs. Each of the vanes may have a base portion, a bend portion located a radial outward distance relative to the base portion, and a tip portion located a radial outward distance relative to the bend portion. Each of the ribs may have a base portion, a bend portion located a radial outward distance relative to the base portion, and a tip portion located a radial outward distance relative to the bend portion. Each of the ribs may be located circumferentially between a pair of successive and neighboring vanes. The bend portions of an immediately neighboring vane and rib may be distanced from each other in order to form a circumferential space between the bend portions.

Other embodiments of the invention will become apparent from the detailed description provided hereinafter. It should be understood that the detailed description and specific examples, while disclosing illustrative embodiments of the invention, are intended for purposes of illustration only and are not intended to limit the scope of the invention.

### BRIEF DESCRIPTION OF THE DRAWINGS

Illustrative embodiments of the present invention will become more fully understood from the detailed description and the accompanying drawings, wherein:

FIG. 1 is a schematic view of an illustrative embodiment of secondary air system used in an automotive exhaust breathing system.

FIG. 2 is a perspective view of an illustrative embodiment of a fluid pump assembly.

FIG. 3 is a perspective view of an illustrative embodiment of an impeller that can be used in a fluid pump assembly.

FIG. 4 is an enlarged view of a portion of the impeller of FIG. 3.

### DETAILED DESCRIPTION OF ILLUSTRATIVE EMBODIMENTS

The following description of the embodiment(s) is merely illustrative in nature and is in no way intended to limit the invention, its application, or uses. Furthermore, cross-hatching or cross-sectional lines provided in the drawings is merely illustrative in nature and is not intended to emphasize a particular part or portion, and is not intended to designate a particular material for a particular part or portion.

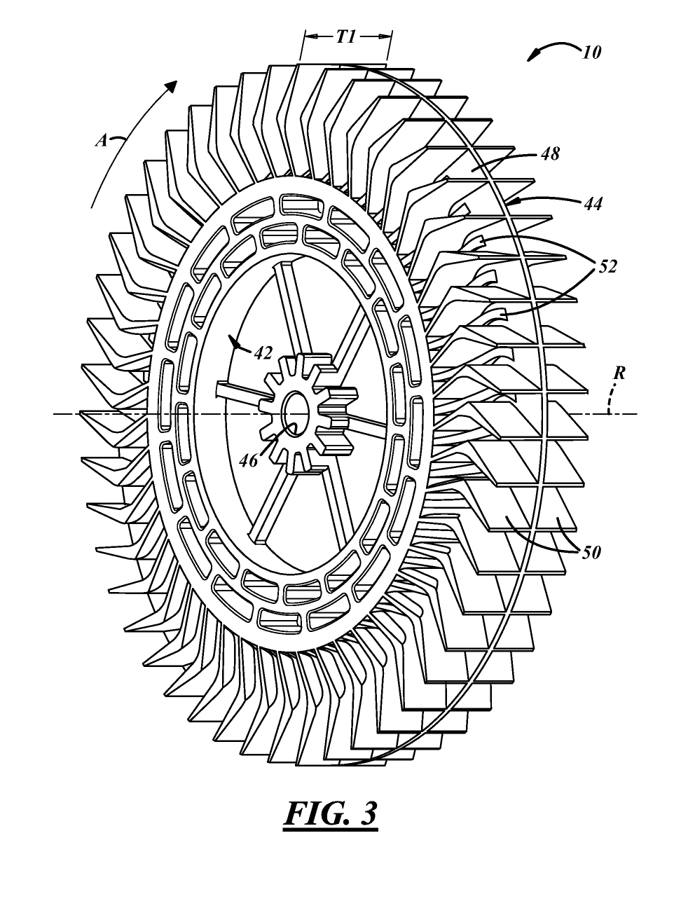

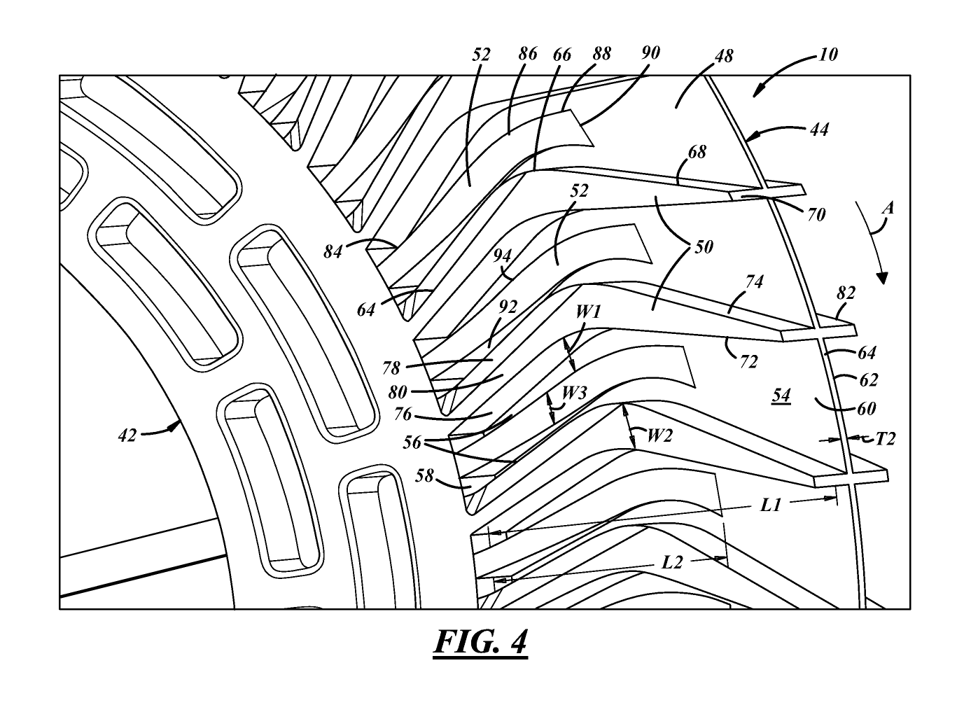

FIGS. 3 and 4 show an illustrative embodiment of an impeller 10 that may be used with a fluid pump assembly 12 such as a secondary air pump assembly equipped in an automotive engine breathing system like an automotive exhaust breathing system. The impeller 10 may be designed, constructed, and arranged to, among other things, help ensure structural integrity of a web of the impeller, help ensure optimum fluid-flow performance of the impeller, and help optimize manufacturing and reduce waste material of the impeller even when vanes of the impeller define a relatively large so-called bucket radius between neighboring and adjacent vanes. To this end, an illustrative embodiment of the impeller 10 may have numerous ribs 14, as will be described.

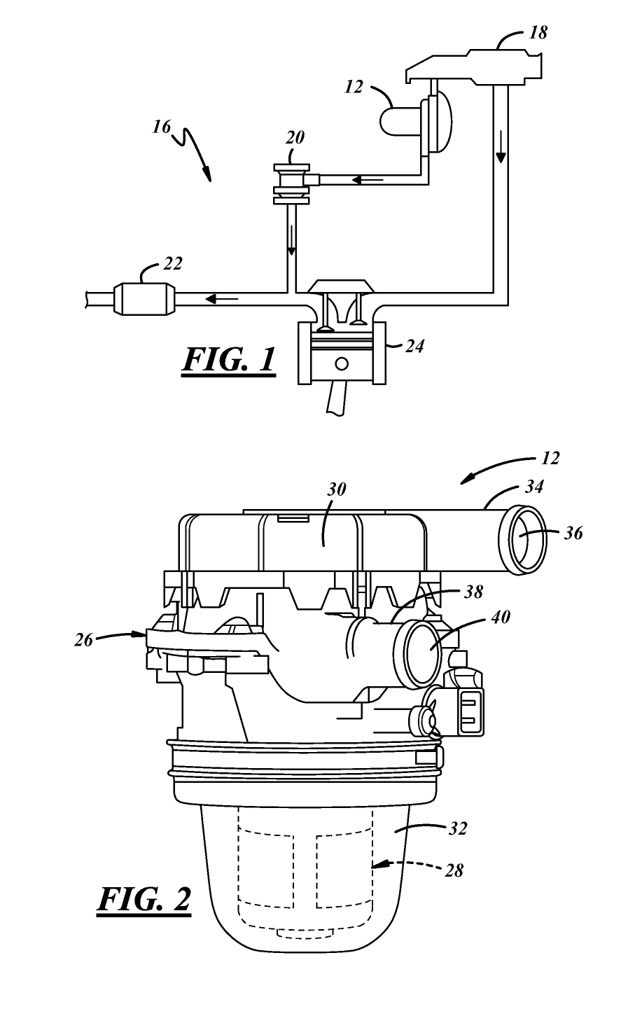

Referring to FIG. 1, the fluid pump assembly 12 may be equipped in a secondary air system 16 of an automotive exhaust breathing system. In the illustrative embodiment of FIG. 1, the secondary air system 16 may include an air filter 18 to filter fluid-flow before it is received in the fluid pump assembly 12, a secondary air valve 20 that opens and closes to permit and prevent fluid-flow thereat, and an exhaust gas treatment component 22 such as a catalytic converter, diesel particulate filter, or similar component. In this illustrative embodiment, the fluid pump assembly 12 may be used to expel pressurized fluid-flow, such as air, to mix with exhaust gases being discharged from an engine 24 such as an automotive internal combustion engine like a diesel or spark-ignited engine. Skilled artisans will understand the general construction, arrangement, and operation of these and similar types of secondary air systems so that a more in-depth description is not provided here.

The fluid pump assembly 12 may be of the regenerative pump type, and may have different constructions, arrangements, and operations including the illustrative embodiment shown in FIG. 2. The fluid pump assembly 12 may include a housing 26, an electric motor 28 (shown in phantom), and the impeller 10 (not shown in FIG. 2). The housing 26 may at least in part support and protect the electric motor 28 and the impeller 10, and may provide acoustic insulation therefor. The housing 26 may be made in one-piece, or may be made of several pieces that are assembled together. The housing 26 may be composed of a metal such as aluminum or steel, a plastic such as a polymeric or composite material, or a combination thereof.

In the embodiment shown, the housing 26 may have a first cover or casing 30 surrounding the impeller 10, and may have a second cover or casing 32 surrounding the electric motor 28. The first casing 30 may have an inlet portion 34 defining an inlet passage 36 to receive incoming fluid-flow and to communicate with other upstream components of the associated automotive engine breathing system. The inlet passage 36 may lead the incoming fluid-flow to the impeller 10. The first casing 30 may also have an outlet portion 38 defining an outlet passage 40 to direct expelled fluid-flow out of the fluid pump assembly 12 and to communicate with other downstream components of the associated automotive engine breathing system.

The electric motor 28 drives and causes the impeller 10 to rotate during use of the fluid pump assembly 12 and upon actuation of the electric motor. The electric motor 28 may be a direct current (d.c.) motor, or another type. In the embodiment shown, the electric motor 28 is enclosed by the second casing 32, but in other embodiments the electric motor may be attached to the first casing 30 and exposed without the second casing. The electric motor 28 may have a shaft (not shown) which is interconnected to the impeller 10 and which spins to rotate the impeller about its axis. As will be appreciated by skilled artisans, the electric motor 28 may further include a stator and a rotor.

The impeller 10 is used in cooperation with structures and surfaces of the housing 26 to energize and pressurize incoming fluid-flow from the inlet passage 36 which is then expelled out of the fluid pump assembly 12 via the outlet passage 40. The impeller 10 may be located in the first casing 30 and may be rotated about an axis of rotation R in a direction of rotation A via the electric motor 28 and the interconnection thereto. In one embodiment, the impeller 10 may have a one-piece body which may be composed of a plastic material and may be manufactured by an injection molding process. In one example, the impeller 10 may have a greatest axial width T1 (FIG. 3) of about 12.45-12.55 mm; of course, other greatest axial width values are possible.

In the illustrated embodiment of the figures, and particularly referring to FIG. 3, the impeller 10 has a generally annular and cylindrical shape which defines various directions with respect to the shape. For example, radially refers to a direction that is generally along an imaginary radius of the annular and cylindrical shape, axially refers to a direction that is generally parallel to the axis of rotation R, and circumferentially refers to a direction that is generally along an imaginary circumference of the annular and cylindrical shape.

Referring to FIGS. 3 and 4, in this illustrated embodiment the impeller 10 may have a hub portion 42 and a vane portion 44. The hub portion 42 may constitute the radially center-most portion of the impeller 10. The hub portion 42 may have a central bore 46 constructed and arranged to receive insertion of the shaft of the electric motor 28. In other embodiments, the hub portion may have different designs, constructions, and arrangements.

The vane portion 44 may be located radially outwardly with respect to the hub portion 42. In the illustrated embodiment, the vane portion 44 may constitute the radially outwardly-most peripheral portion of the impeller 10; in other embodiments, the vane portion need not constitute the radially outwardly-most peripheral portion of the impeller, and instead may be located radially inwardly with respect to another portion of the impeller that is the outwardly-most peripheral portion. The vane portion 44 may have a web 48, numerous vanes 50, and numerous ribs 52.

The web 48 may at least partly extend between and may at least partly connect the vanes 50 and the ribs 52. In the illustrated embodiment, the web 48 may be a radially extending plane that is normal to the axis of rotation R, and the web may extend circumferentially continuously around the vane portion 44. Referring to FIG. 4, the web 48 may define first channels or spaces 54 in which there is no intervening structures between neighboring and immediately successive vanes 50 and their respective confronting surfaces, and may define second channels or spaces 56 in which there is no intervening structures between neighboring and immediately successive ribs 52 and vanes and their respective confronting surfaces. In one example, the second spaces 56 may have a circumferential width W1 of about 0.72-0.82 mm; of course, other circumferential width values are possible. The web 48 may extend radially from the hub portion 42, and from an axially extending transition or hub surface 58 of the hub portion. The web 48 may have a first face surface 60, a second face surface 62, and a terminal or free end 64 constituting the radially outwardly-most end of the web 48. In one example, the web 48 may have an axial thickness T2 of about 0.7-0.9 mm; of course, other axial width values are possible.

The vanes 50 may be constructed and arranged to move fluid-flow during energization and pressurization thereof. The vanes 50 may have different designs, constructions, and arrangements including that shown in FIGS. 3 and 4. In the illustrated embodiment, the vane portion 44 may have forty-seven individual vanes 50 that may be substantially identical in shape and contour with respect to one another; of course, other numbers of individual vanes are possible. The vanes 50 may be arrayed around the vane portion 44 and may be equally circumferentially spaced with respect to one another. Referring in particular to FIG. 4, the vanes 50 may be circumferentially separated from one another via the first and second spaces 54, 56 and the ribs 52. Each individual vane 50 may project radially from the hub portion 42 and from the hub surface 58, and may project axially from both of the first and second face surfaces 60, 62 of the web 48.

Each vane 50 may have a generally curvilinear profile, and may have a base portion 64, an intermediate or bend portion 66 located radially outwardly with respect to the base portion, and a tip portion 68 located radially outwardly with respect to the bend portion. The base portion 64 may extend and may transition directly and immediately from the hub portion 42 and from the hub surface 58. The bend portion 66 may extend directly from the base portion 64. The bend portion 66 may help define a so-called bucket radius of an individual vane 50. In some cases, the size of the bucket radius may influence the performance of the impeller 10; for example, a relatively large bucket radius may create a more swirling-flow-effect which may be desirable in some applications. In some cases, having a larger bucket radius may require having a greater value for a circumferential width W2 at the bend portion 66 due to manufacturing and structural concerns. The tip portion 68 may extend directly from the bend portion 66, and may have a terminal or free end 70 constituting the radially outwardly-most end of each vane 50. The free ends 70 of each vane 50 may be radially coextensive with the free end 64 of the web 48; in other embodiments, the free ends of each vane can extend radially outwardly farther than the free end of the web, in which case the total radial length of the each vane (taken from base portion 64 to tip portion 68) is greater than the total radial length of the web (taken from hub surface 58 to free end 64).

Each vane 50 may also have a leading side surface 72 and a trailing side surface 74. The leading side surface 72 may be generally circumferentially-facing and may be directed to generally face the direction of rotation A (i.e., leading direction), and the trailing side surface 74 may be generally circumferentially-facing and may be directed to generally face in the opposite direction of the direction of rotation A (i.e., trailing direction). The leading side surface 72 may have a generally concave shape, and the trailing side surface 74 may have a generally convex shape. The leading side surface 72 may have a chamfer or slant 76, and the trailing side surface 74 may also have a chamfer or slant 78. The leading and trailing side surface 72, 74 may converge toward each other radially outwardly at the respective free end 70. Each vane 50 may also have a first and second face surface 80, 82.

Still referring to FIG. 4, each vane 50 may define a radial length L1 that generally measures the length of each vane in the radial direction from the hub surface 58 to its free end 70. In the illustrated embodiment, the measurement does not follow the exact curvilinear profile of each vane 50. The radial length L1 may have the same value as the radial length of the web 48.

The ribs 52 may be a thickened portion as compared to the immediately surrounding web 48, may impart strength and stiffness to the vane portion 44, and may beneficially influence the hardening and solidifying behavior of the vane portion at the ribs and physically beyond the immediate vicinity and structure of the ribs during the injection molding process of the impeller 10. For example, the ribs 52 may increase the amount of time required for hardening and solidification at the end of the injection molding process, which may help prevent warping, non-uniform cooling, internal voids, and other degradations in the vane portion 44 and particularly in the vanes 50. In some cases, these degradations may cause a mass imbalance in the impeller 10 itself which may negatively affect the performance of the impeller during use, including generating excessive vibrations and noise during rotation at increased speeds. Best practice guidelines for an injection molding process may call for a generally uniform and consistent wall cross-sectional thickness throughout the plastic part being formed—also known as nominal wall thickness. These guidelines generally recommend reducing the wall thickness variation or difference between adjacent portions of the plastic part. In the illustrated embodiment, the ribs 52 may be designed, constructed, and arranged to suitably reduce the wall thickness variation between the vanes 50 and the web 48—particularly the comparatively thick base and bend portions 64, 66—while minimizing the amount of material used and maintaining suitable performance of the impeller 10.

The ribs 52 may have different designs, constructions, and arrangements including that shown in FIGS. 3 and 4. In the illustrated embodiment, the vane portion 44 may have forty-seven individual ribs 52 that may be substantially identical in shape and contour with respect to one another; of course, other numbers of individual ribs are possible. The ribs 52 may be arrayed around the vane portion 44 and may be equally circumferentially spaced with respect to one another. Referring in particular to FIG. 4, the ribs 52 may be circumferentially separated from one another via the second spaces 56 and vanes 50. Each individual rib 52 may be located circumferentially between a pair of neighboring and immediately successive vanes 50. Each rib 52 may project radially from the hub portion 42 and from the hub surface 58, and may project axially from both of the first and second face surfaces 60, 62 of the web 48.

In general, the shape of the ribs 52 may be influenced at least in part by the shape of the vanes 50. In the illustrated embodiment, each rib 52 may have a generally curvilinear profile, and may have a base portion 84, an intermediate or bend portion 86 located radially outwardly with respect to the base portion, and a tip portion 88 located radially outwardly with respect to the bend portion. The base portion 84 may extend and may transition directly and immediately from the hub portion 42 and from the hub surface 58. The bend portion 86 may extend directly from the base portion. And the tip portion 88 may extend directly from the bend portion 86, and may have a terminal or free end 90 constituting the radially outwardly-most end of each rib 52. The free ends 90 of each rib 52 may be located radially inwardly with respect to the free end 64 of the web 48, and with respect to the free ends 70 of the vanes 50. Each rib 52 may taper in axial thickness beginning at its base portion 84 and extending to its free end 90; in other words, each rib may taper in axial thickness from thicker to thinner in the radially outwardly direction, and in this sense may have a ramp shape. Tapering the axial thickness in this way may help avoid interference with fluid-flow movement caused by the vanes 50 during energization and pressurization of the fluid-flow, and may reduce the amount of material used to form the ribs 52. The axial thickness of each rib 52 at its base portion 84 and at the hub surface 58 may have the same value as the axial thickness of each vane 50 at its base portion 64.

Each rib 52 may also have a leading side surface 92 and a trailing side surface 94. The leading side surface 92 may be generally circumferentially-facing and may be directed to generally face the direction of rotation A (i.e., leading direction), and the trailing side surface 94 may be generally circumferentially-facing and may be directed to generally face in the opposite direction of the direction of rotation A (i.e., trailing direction). The leading side surface 92 may have a generally concave shape, and the trailing side surface 94 may have a generally convex shape. The leading side surface 92 may directly confront the trailing side surface 74 across the second space 56 of the immediately neighboring vane 50, and likewise the trailing side surface 94 may directly confront the leading side surface 72 across the second space of the immediately neighboring vane. The leading side surface 92 of each rib 52 may be spaced a circumferential distance from the directly confronting trailing side surface 74 of the immediately neighboring vane 50. The circumferential distance may be maintained throughout the radial extent of each rib 52 from its base portion 84 and from the hub surface 58, and to its free end 90. And likewise the trailing side surface 94 of each rib 52 may be spaced a circumferential distance from the directly confronting leading side surface 72 of the immediately neighboring vane 50. The circumferential distance may be maintained throughout the radial extent of each rib 52 from its base portion 84 and from the hub surface 58, and to its free end 90.

Referring to FIG. 4, each rib 52 may define a radial length L2 that generally measures the length of each rib in the radial direction from the hub surface 58 to its free end 90. In the illustrated embodiment, the measurement does not follow the exact curvilinear profile of each rib 52. The radial length L2 may have a value which is less than the value of the radial length L1 of the vanes 50, and the radial length L2 may have a value which is less than the value of the radial length of the web 48. In some cases, having the radial length L2 less than the radial length L1 may help avoid interference with fluid-flow movement caused by the vanes 50 during energization and pressurization of the fluid-flow, and may reduce the amount of material used to form the ribs 52. In one example, each rib 52 may have a circumferential width W3 of about 0.86-0.96 mm; of course, other circumferential width values are possible. In at least one embodiment, the circumferential width W3 of each rib may be approximately equal to a circumferential width of each vane.

In other embodiments not illustrated, the vanes and ribs may have different designs, constructions, and arrangements. For example, i) the vanes need not have a bend portion and instead can be substantially radially straight, ii) the ribs need not be spaced from the vanes for the full radial extent of the ribs and instead portions of the ribs, such as base portions, may come into contact with portions of the vanes, and iii) the ribs need not necessarily be designed and constructed identically to one another and instead less than all of the ribs may be designed with base portions that are integral with base portions of the vanes. Other examples exist.

The above description of embodiments of the invention is merely illustrative in nature and, thus, variations thereof are not to be regarded as a departure from the spirit and scope of the invention.

What is claimed is:

1. A product comprising:
an impeller (10) of a fluid pump assembly (12), the impeller comprising a plurality of vanes (50), a web (48), and a plurality of ribs (52), each of the plurality of vanes having a base portion (64) and a tip portion (68) located radially outwardly with respect to the base portion, the web extending between and connecting the plurality of vanes and the plurality of ribs, each of the plurality of ribs having a base portion (84) and a tip portion (88) located radially outwardly with respect to the base portion, at least some of the plurality of ribs being located circumferentially between a pair of successive vanes, a generally circumferentially-facing side surface (92, 94) of at least some of the plurality of ribs generally confronts a generally circumferentially-facing side surface (72, 74) of an immediately neighboring vane and defines a circumferential space (56) therebetween throughout at least some of a radial extent of the ribs.

2. A product as set forth in claim 1 wherein a second generally circumferentially-facing side surface of at least some of the plurality of ribs generally confronts a second generally circumferentially-facing side surface of an immediately neighboring vane and defines a second circumferential space (56) therebetween throughout at least some of the radial extent of the ribs.

3. A product as set forth in claim 1 wherein the impeller comprises a hub portion (42) and a vane portion (44), the vane portion extending from the hub portion at a transition hub surface (58), the vane portion including the plurality of vanes, the web, and the plurality of ribs, the circumferential space is defined between respective and confronting circumferentially-facing side surfaces of the ribs and vanes throughout the radial extent of the ribs from the transition hub surface to a free end (90) of the ribs.

4. A product as set forth in claim 1 wherein each of the plurality of vanes has a first radial length (L1), and each of the plurality of ribs has a second radial length (L2), the second radial length having a value that is less than a value of the first radial length.

5. A product as set forth in claim 1 wherein the impeller comprises a hub portion (42) and a vane portion (44), the vane portion including the plurality of vanes, the web, and the plurality of ribs, the base portions of the vanes and of the ribs extending from the hub portion, free ends (70) of each of the tip portions of the vanes being radially coextensive with a free end (64) of the web, and free ends (90) of each of the tip portions of the ribs being located radially inwardly with respect to the free end of the web.

6. A product as set forth in claim 1 wherein each of the plurality of ribs has a leading side surface (92) generally facing in a direction of rotation (A) of the impeller, each of the plurality of ribs has a trailing side surface (94) generally facing in a direction that is opposite the direction of rotation of the impeller, the leading side surface of each rib generally confronts a trailing side surface (74) of an immediately neighboring vane and is located a distance therefrom throughout the radial extent of the rib from the base portion of the rib to the tip portion of the rib to define a first circumferential space (56), the trailing side surface of each rib generally confronts a leading side surface (72) of an immediately neighboring vane and is located a distance therefrom throughout the radial extent of the rib from the base portion of the rib to the tip portion of the rib to define a second circumferential space (56).

7. A product as set forth in claim 1 wherein each of the plurality of ribs tapers in axial thickness from the base portion of the rib and radially outwardly to the tip portion of the rib.

8. A product as set forth in claim 1 wherein each of the plurality of vanes has a bend portion (66) located radially outwardly with respect to the base portion of the vane and located radially inwardly with respect to the tip portion of the vane, the bend portion providing a generally concave shape to a leading side surface (72) of each of the plurality of vanes, the leading side surfaces of each of the plurality of vanes generally facing in a direction of rotation (A) of the impeller, each of the plurality of ribs has a bend portion (86) located radially outwardly with respect to the base portion of the rib and located radially inwardly with respect to the tip portion of the rib, the bend portion providing a generally concave shape to a leading side surface (92) of each of the plurality of ribs, the leading side surfaces of each of the plurality of ribs generally facing in a direction of rotation of the impeller.

9. A product as set forth in claim 1 wherein the impeller comprises a hub portion (42) and a vane portion (44) located radially outwardly with respect to the hub portion, the vane portion including the plurality of vanes, the web, and the plurality of ribs, the vane portion constituting the radially outwardly-most peripheral portion of the impeller.

10. A product as set forth in claim 1 wherein the web has a first radial length, and each of the plurality of vanes has a second radial length, the second radial length having a value that is greater than a value of the first radial length.

11. A product as set forth in claim 1 wherein the fluid pump assembly is a secondary air pump assembly of an automotive exhaust breathing system.

12. A product comprising:
a fluid pump assembly (12) of an automotive exhaust breathing system, the fluid pump assembly comprising:
a housing (26) having an inlet portion (34) to receive fluid-flow and an outlet portion (38) to expel fluid-flow;
an electric motor (28) supported at least in part by the housing; and
an impeller located in the housing and being rotated by the electric motor upon actuation, the impeller having a hub portion and a vane portion, the vane portion extending from the hub portion at a transition hub surface, the vane portion having a plurality of vanes, a web, and a plurality of ribs, each of the plurality of vanes having a base portion at the transition hub surface and a free end located radially outwardly with respect to the base portion, each of the plurality of vanes having a leading side surface generally facing in a direction of rotation of the impeller and a trailing side surface generally facing in a direction that is opposite the direction of rotation, the web extending between and connecting the plurality of vanes and the plurality of ribs, each of the plurality of ribs being located circumferentially between a pair of successive vanes, each of the plurality of ribs having a base portion at the transition hub surface and a free end located radially outwardly with respect to the base portion of the rib, each of the plurality of ribs having a leading side surface generally facing in the direction of rotation and a trailing side surface generally facing in the direction that is opposite the direction of rotation, the leading side surface of each vane generally confronts the trailing side surface of the immediately neighboring rib and is spaced a circumferential distance therefrom throughout a radial extent of the rib from the base portion of the rib to the free end of the rib, the trailing side surface of each vane generally confronts the leading side surface of the immediately neighboring rib and is spaced a circumferential distance therefrom throughout the radial extent of the rib from the base portion of the rib to the free end of the rib.

13. A product as set forth in claim 12 wherein the free ends of each of the plurality of vanes are radially coextensive with a free end of the web, and the free ends of each of the plurality of ribs are located radially inwardly with respect to the free end of the web.

14. A method comprising:
injection molding an impeller of a fluid pump assembly, the impeller comprising a plurality of vanes, a web, and a plurality of ribs, each of the plurality of vanes having a base portion, having a bend portion located radially outwardly with respect to the base portion, and having a tip portion located radially outwardly with respect to the bend portion, each of the plurality of ribs having a base portion, having a bend portion located radially outwardly with respect to the base portion, and having a tip portion located radially outwardly with respect to the bend portion, each of the plurality of ribs being located circumferentially between a pair of successive vanes, the respective bend portions of an immediately neighboring vane and rib being distanced from each other to form a circumferential space therebetween.
